(19) United States
(12) Patent Application Publication
(10) Pub. No.: US 2008/0273444 A1
(43) Pub. Date: Nov. 6, 2008

(54) Holographic Record Carrier

(76) Inventors: Masakazu Ogasawara, Tokyo (JP); Yoshihisa Itoh, Tokyo (JP); Yoshihisa Kubota, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/547,102

(22) PCT Filed: Mar. 15, 2005
(86) PCT No.: PCT/JP2005/005051

§ 371 Date: Jan. 30, 2007

(30) Foreign Application Priority Data
Mar. 30, 2004 (JP) 2004-098241

(51) Int. Cl. G11B 7/00

(52) U.S. Cl. 369/103

(57) ABSTRACT

A holographic record carrier is capable of recording or reproducing information by irradiating light. The holographic record carrier is comprised of a holographic recording layer for storing an optical interference pattern produced by a signal light component of a coherent reference light and a signal light as a diffraction grating therein; a reflective layer stacked on the holographic recording layer in the opposite side of the light incidence side; and a plurality of non-reflective regions arranged on the reflective layer in the same interval as the record-interval of the diffraction grating.

### TECHNICAL FIELD

The present invention relates to a holographic record carrier such as an optical disk or card or the like with which information is optically recorded or reproduced, and more particularly, to a holographic record carrier which has a recording layer irradiated with an optical beam for recording information thereon or reproducing information therefrom.

### BACKGROUND ART

A hologram has drawn attention because of its ability to record two-dimensional data at a high density, for use in high density information recording. The hologram is characterized by volumetrically recording a wave front of light, which carries out recording of information on a recording medium made of a photosensitive material such as a photo-refractive material as changes in refractive index as a refraction grating. Multiplex recording on the holographic record carrier can dramatically increase the recording capacity. There are included angle multiplexing, phase coding multiplexing and the like in the multiplex recording in which information can be recorded multiple times by changing the incident angle or phase of interfering light waves even in a multiplexed hologram region. For example, a recording and reproducing system which utilizes the holographic record carrier as a disk has been developed (see Laid-open Japanese Patent Application Kokai No. 11-311937).

In the developed holographic recording system, reference light is converged on the reflective film through the recording layer as a spot, and the reference light reflected by the reflective film diverges to pass through the recording layer again, and simultaneously, information light, which carries information to be recorded, is passed through the recording layer at the same area. In this way, in the recording layer, the reflected reference light interferes with the information light to form an interference pattern to volumetrically record hologram as a refraction grating within the recording layer. The holograms of the interference pattern are recorded in the recording layer adjacent to each other, overlapping in sequence. Then, the reference light is irradiated to detect and demodulate reproduced light restored from each hologram to reproduce recorded information.

In the case that the reference light and information light coaxially impinge from the same side of the recording layer, it is difficult to separate the reference light reflected on the reflective film from the reproduced light from the holograms during reproduction of information. This causes the performance of reading a reproduced signal to be degraded.

To solve these problems, the holographic recording system shown in Laid-open Japanese Patent Application No. 11-311937 is provide with an objective lens immediately preceded by a bisect azimuth rotator which is a rotator having a pupil divided into two areas, which have respective optical rotating directions different by 90° from each other to prevent the reference light from impinging on a photodetector.

### DISCLOSURE OF THE INVENTION

However, the conventional method involves a problem that the bisect azimuth rotator and the objective lens must be integrally driven. The conventional method also has a problem of a deteriorated recording characteristic from reproduced light corresponding to the vicinity of the division boundary of the bisect azimuth rotator.

In the case that a hologram is recorded in such a holographic record carrier of reflective type, four kinds of hologram are recorded by interference due to four light beams of entering reference light and signal light and reflected reference light and signal light, thereby wastefully using holographic recording layer performance.

Further, when reproducing information, it is difficult to separate diffracted light caused by a reproduced hologram from reflected reference light, because the reference light is reflected from the reflective film of the holographic record carrier. Accordingly, readout performance of the reproduced signal is deteriorated. Further, since a reflected hologram image is recorded, the reproduced signal is deteriorated.

It is therefore an exemplary object of the present invention to provide a holographic record carrier, a recording/reproducing and hologram device capable of providing recording and reproduction stability.

It is therefore an exemplary object of the present invention to provide a holographic record carrier, a recording/reproducing method therefor, and a hologram apparatus which are capable of stably recording or reproducing information.

A holographic record carrier according to the present invention, which is irradiated with light for recording information thereon and reproducing information therefrom, comprises:

a holographic recording layer for storing optical interference patterns as diffraction gratings therein produced by coherent components of reference light and signal light;

a reflective layer disposed on one side of said holographic recording layer opposite to a side which is irradiated with light; and

a plurality of non-reflective regions arranged on said reflective layer at the same intervals as record-intervals of said diffraction gratings.

### BRIEF DESCRIPTION OF THE DRAWINGS

FIG. 1 is a partially sectional schematic view of a holographic record carrier in accordance with a preferred embodiment of the present invention.

FIG. 2 is a partially sectional schematic view of a holographic record carrier in accordance with another embodiment of the present invention.

FIG. 3 is a partially perspective schematic view of a holographic record carrier in accordance with yet another embodiment of the present invention.

FIG. 4 is a block diagram showing a schematic configuration of a holographic device for recording or reproducing information from a holographic record carrier in accordance with the preferred embodiment of the present invention.

FIG. 5 is a perspective view schematically showing a pickup of a holographic device for recording and reproducing information from a holographic record carrier in accordance with the preferred embodiment of the present invention.

FIG. 6 is a configuration view schematically showing a pickup of a holographic device for recording and reproducing information from a holographic record carrier in accordance with the preferred embodiment of the present invention.

FIG. 7 is a perspective view schematically showing a three axes actuator for an objective lens in a pickup of a holographic device for recording and reproducing information from a holographic record carrier in accordance with the preferred embodiment of the present invention.

FIGS. 8 and 9 are configuration views schematically showing a pickup of a holographic device for recording and reproducing information from a holographic record carrier in accordance with the preferred embodiment of the present invention.

FIG. 10 is a planar view showing part of a photodetector in a pickup of a holographic device for recording and reproducing information from a holographic record carrier in accordance with the preferred embodiment of the present invention.

FIG. 11 is a partially sectional schematic view of recording and reproduction of information from a holographic record carrier in accordance with the preferred embodiment of the present invention.

FIG. 12 is a partially sectional schematic view of a process of recording information in a holographic record carrier in accordance with the preferred embodiment of the present invention.

FIG. 13 is a partially sectional schematic view of a process of reproducing information from a holographic record carrier in accordance with the preferred embodiment of the present invention.

FIG. 14 is a configuration view showing a holographic device in accordance with another embodiment of the present invention.

FIGS. 15 to 20 are planar views each showing a track configuration of a holographic record carrier in accordance with examples of the present invention.

FIG. 21 is a perspective view showing a holographic record carrier in accordance with the preferred embodiment of the present invention.

FIG. 22 is a perspective view showing a holographic optical card in accordance with another embodiment of the present invention.

### DETAILED DESCRIPTION OF THE INVENTION

In the following, embodiments of the present invention will be described with reference to the drawings.

### <Holographic Record Carrier>

In a Holographic Recording/Reproducing Apparatus, holographic recording is performed by using a first light beam causing a reference light and a signal light interfering with each other, and at the same time using a servo beam of laser light with a different wavelength from the first light beam to carry out a servo control (focusing and tracking) on relative positioning of a holographic record carrier and a pickup device particularly an object lens thereof. The following description is an example of such device.

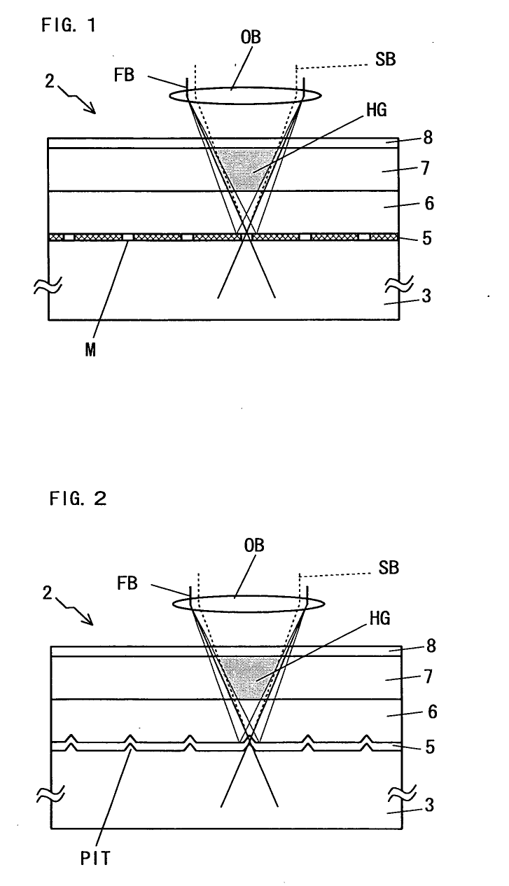

FIG. 1 shows a holographic record carrier 2 of disk-shaped, an exemplary embodiment of the present invention, on which information recording or reproduction is preformed with light irradiation.

The holographic record carrier 2 comprises a substrate 3 with transferred tracks, a reflective layer 5, a separation layer 6, a holographic recording layer 7, and a protective layer 8 which are laminated on the substrate 3 from an opposite side to a side from which reference light impinges. As such, the reflective layer 5 is arranged over or on the opposite side of the substrate 3 to the optical irradiation side which is directed to the holographic record carrier. The reflective layer 5 has marks M, each serving as a non-reflective region, formed in the same interval as a multiple interval Px of the hologram. The holographic recording is performed while matching laser light (servo beam SB) used of the servo control with each mark M so that both optical axes of the servo beam SB the first light beam FB are nearly coaxial with each other. Each of the marks may be a pinhole PH (FIG. 1) through which a reference light or a light beam (Zero-order beam) that is not modulated by a spatial optical modulator passes, or may be the same configuration (FIG. 2) as a pit having a specific shape not to return the Zero-order light to the optical axis. Each pinhole PH may be a hole that is physically punched through a reflective layer 5 consisting of a metallic reflective layer such as an aluminum or dielectric multi-layer, or may be a circular region having a low reflectivity at a wavelength used to record the hologram. The diameter of the non-reflective region of each pinhole PH or the like is dimensioned so as to pass the reference light or the beam (Zero-order beam) that was not modulated by the spatial optical modulator. Generally, the diameter of the non-reflective region is designed to have the size of a spot on a Fourier imaging face determined by the number of openings of the objective lens and the wavelength used for holographic recording. As such, in the present embodiment, non-reflective region such as pinholes PH are formed on the reflective layer 5, each of which passes a reference light component for recording or reproducing the hologram to a rear side of the holographic record carrier 2 (not to be returned to the objective lens side). Accordingly, in order that the first light beam FB is not returned to the objective lens, the non-reflective region may have a permeability of a characteristic value higher than that of the reflective layer 5, or have an absorption ratio of a characteristic value higher than that of the reflective layer 5. Characteristic values of reflectivity, permeability and absorption ratio of the non-reflective region may be characteristic values in a wavelength of coherent reference light or signal light. For example, the non-reflective region may have permeability lower than that of the reflective layer 5 in a wavelength of a servo beam SB. If pinholes PH of the reflective layer 5 is arranged in a line in a y direction along which holograms are sequentially recorded and a direction perpendicular to they direction is as an x direction, then the pinholes PH are arranged in a pitch Py and in a pitch Px.

The holographic recording layer 7 stores an optical interference pattern as a refraction grating (hologram) produced by components of the coherent reference light and signal light included in the first light beam FB. The first light beam FB including the components of the reference light and signal light to record the hologram is used when information recording. On the other hand during information reproduction the first light beam FB consisting of the reference light component alone is used. Further, in the case of phase encoding multiple reproducing, the first light beam FB includes a phase modulation pattern and a reference light component, although it does not include the signal light component. The holographic recording layer 7 for preserving an optical interference pattern is made of a photo-sensitive material such as a photo-refractive material, a hole burning material, a photo-chromic material or the like.

The reflective layer 5 is made, for example, of a metal film, a phase-change film, a dye film or the like or a combination thereof, which is set to reflect the first light beam FB for the holographic recording. A position decision servo control (focusing servo and x- and y-directions servo controls) is conducted on the basis of detections of irradiation and reflection of the servo beam SB of holographic recording.

The substrate 3 is made may be, for example, glass, polycarbonate, amorphous polyolefin, polyimide, plastics such as PET, PEN, PES, ultraviolet curing acrylic resin, and the like. The substrate 3 has a plurality of tracks T formed on the main surface in the form of grooves that extend spaced away from each other without intersection. The reflective layer 5 functions as a guiding layer. The separation layer 6 and protective layer 8 are made of an optically transparent material, and function to planarize the laminate and protect the holographic recording layer and the like.

The servo beam SB is focused on the pinhole PH in order to read the servo track or pit formed on the substrate 3. The pinhole PH may be filled with a material having a property to transmit the reference light component (Zero-order beam) of the first light beam FB.

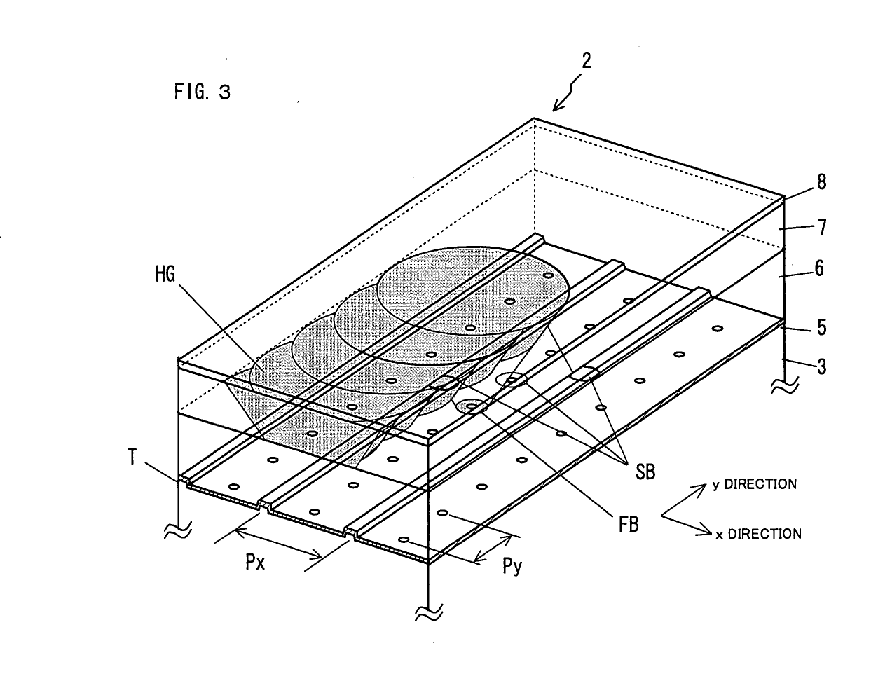

As shown in FIG. 3, the track T is formed between adjacent mark lines of pinholes PH (non-reflective region arrays) so that the interval of tracks is the same as a holographic recording gap. The track T may employ the grove shape that is generally used in optical disks, and may be a region having a different reflectivity. The track Ton the substrate is provided to perform at least a servo control of the tracking servo. The hologram HG is recorded three-dimensionally in an upper portion of the holographic recording layer 7 between one track T and another track T. For conducting a tracking servo control on the disk-shaped substrate 3, the tracks T may be formed spirally or concentrically on the substrate with respect to the center thereof, or in a plurality of cut spiral arcs.

The servo control is conducted by driving an objective lens by an actuator in accordance with a detected signal, using a pickup which includes a light source for emitting a light beam, an optical system including an objective lens for converging the light beam on the reflective layer 5 as a light spot and leading its reflected light to a photodetector, and the like. The diameter of the light spot is set to be narrowed down to a value determined by the wavelength of the light beam and the numerical aperture (NA) of the objective lens (a so-called diffraction limit which is, for example, 0.82λ/NA (λ=wavelength), but is determined only by the wavelength of light and the numerical aperture when aberration is sufficiently small as compared with the wavelength). In other words, the light beam-radiated from the objective lens is used such that it is focused when the reflective layer lies at the position of its beam waist. The width of the grooves is determined as appropriate in accordance with an output of the photodetector which receives the reflected light from the light spot such as a push-pull signal.

The foregoing embodiment has shown a holographic record carrier, the structure of which has the reflective layer 5 and the holographic recording layer 7 laminated with intervention of a separation layer. In addition to such holographic record carrier, in another embodiment, such a separation layer may be omitted. Moreover, a still another embodiment as an exemplary modification includes a holographic record carrier which has a separation layer of substrate 3 interposed between the reflective layer 5 and holographic recording layer 7.

### <Holographic Recording/Reproducing Apparatus>

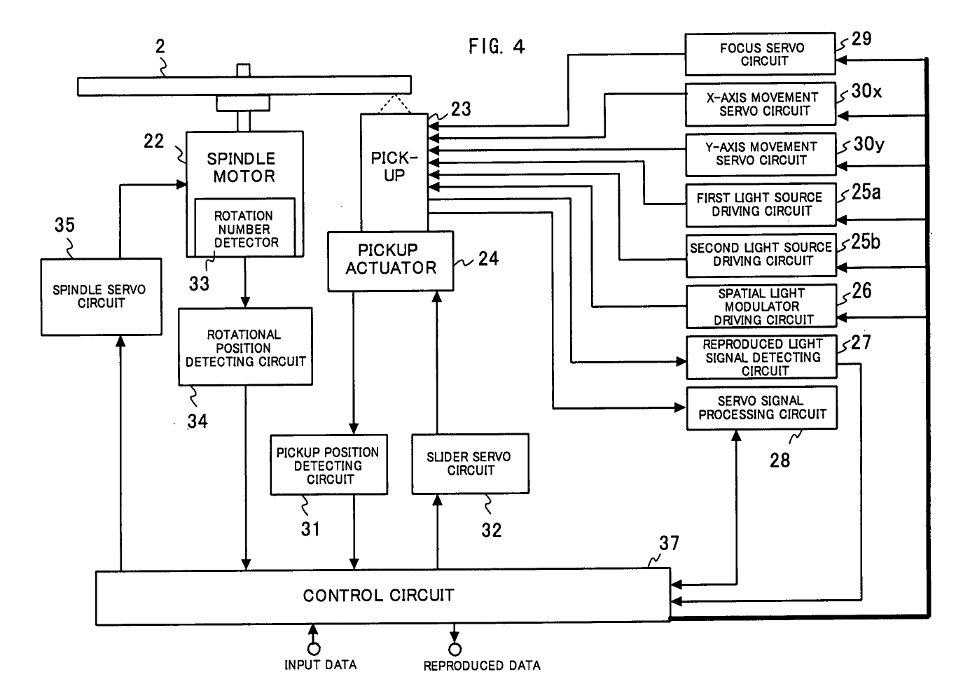

FIG. 4 generally shows an exemplary configuration of a recording/reproducing apparatus for recording or reproducing information to or from a holographic record carrier to which the present invention is applied.

The holographic recording/reproducing apparatus of FIG. 4 comprises a spindle motor 22 for rotating a disk 2, which is a holographic record carrier, through a turn table; a pickup device 23 for reading a signal from the holographic record carrier 2 with a light beam; a pickup actuator 24 for holding and moving the pickup in a radial direction (x-direction); a first laser source driving circuit 25a; a second laser source driving circuit 25b; a spatial light modulator driving circuit 26; a reproduced signal processing circuit 27; a servo signal processing circuit 28; a focusing servo circuit 29; an x-direction movement servo circuit 30x; a y-direction movement servo circuit 30y; a pickup position detecting circuit 31 connected to the pickup actuator 24 for detecting a pickup position signal; a slider servo circuit 32 connected to the pickup actuator 24 for supplying a predetermined signal to the pickup actuator 24; a rotation encoder 33 connected to the spindle motor 22 for detecting a rotational speed signal of the spindle motor; a rotation detector 34 connected to the rotation encoder 33 for generating a rotating position signal of the holographic record carrier 2; and a spindle servo circuit 35 connected to the spindle motor 22 for supplying a predetermined signal to the spindle motor 22.

The holographic recording/reproducing apparatus comprises a controller circuit 37 which is connected to first laser source driving circuit 25a, second laser source driving circuit 25b, spatial light modulator driving circuit 26, reproduced signal processing circuit 27, servo signal processing circuit 28, focusing servo circuit 29, x-direction movement servo circuit 30x, y-direction movement servo circuit 30y, pickup position detecting circuit 31, slider servo circuit 32, rotation encoder 33, a rotation detector 34, and spindle servo circuit 35. The controller circuit 37 conducts a focusing servo control, an x- and y-direction movement servo control, a reproduced position (position in the x- and y-direction) control, and the like related to the pickup through the foregoing circuits connected thereto based on signals from these circuits. The controller circuit 37, which is based on a microcomputer that is equipped with a variety of memories for controlling the overall apparatus, generates a variety of control signals in accordance with manipulation inputs from the user from an operation unit (not shown) and a current operating condition of the apparatus, and is connected to a display unit (not shown) for displaying an operating situation and the like for the user. The controller circuit 37 is also responsible for processing such as encoding of data to be recorded, input from the outside, and the like, and supplies a predetermined signal to the spatial light modulator driving circuit 26 for controlling the recording sequence. Furthermore, the controller circuit 37 performs demodulation and error correction processing based on signals from the reproduced signal processing circuit 27 to restore data recorded on the holographic record carrier. In addition, the controller circuit 37 decodes restored data to reproduce information data which is output as reproduced information data.

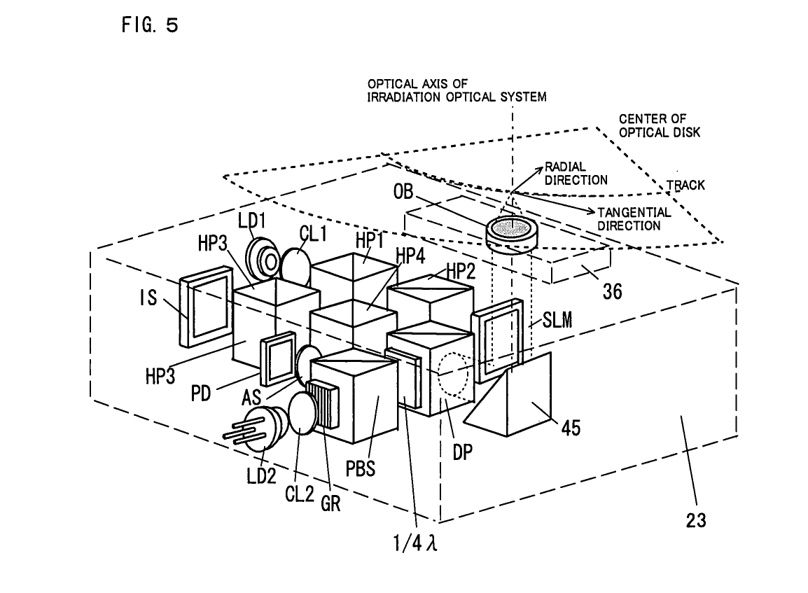

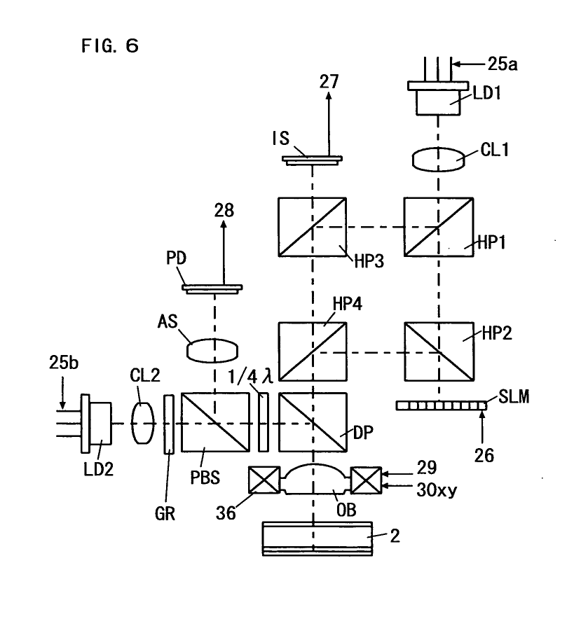

FIGS. 5 and 6 generally show the configuration of the pickup of the recording/reproducing apparatus. The pickup device 23 generally comprises a recording/reproducing optical system, a servo system, and a common system thereto. These systems are placed substantially on the common plane except for the objective lens OB.

The recording/reproducing optical system comprises a first laser source LD1 for recording and reproducing holograms, a first collimator lens CL1, a first half mirror prism HP1, a second half mirror prism HP2, a polarizing spatial light modulator SLM, a reproduced signal detector including an image sensor IS comprised of an array such as a CCD, a complimentary metal oxide semiconductor device, or the like, a third half mirror prism HP3, and a fourth half mirror prism HP4.

The servo system comprises an objective lens actuator 36 for servo-controlling (movements in the x-, y-, z-directions) of the position of a light beam with respect to the holographic record carrier 2, a second laser source LD2, a second collimator lens CL2, a diffraction optical element GR such as a grating or the like for generating a multi-beam for a servo light beam, a polarization beam splitter PBS, a quarter wavelength plate ¼λ, a coupling lens AS, and a servo signal detector including a photodetector PD.

The common system comprises a dichroic prism DP and the objective lens OB.

As shown in FIGS. 5 and 6, half mirror surfaces of the first, third and fourth half mirror prisms HP1, HP3, and HP4 are disposed to be parallel with one another. In a normal direction of these half mirror planes, the half mirror plane and the separation planes of the second half mirror prism HP2 and the dichroic prism DP and polarization beam splitter PBS are in parallel with one another. These optical parts are disposed such that the optical axes (one-dot chain lines) of light beams from the first and second laser sources LD1 and LD2 extend to the recording and reproducing optical system and servo system, respectively, and substantially coincide with one another in the common system.

The first laser source LD1 is connected to the first laser source driving circuit 25a, and has its output adjusted by the first laser source driving circuit 25a such that the intensity of an emitted light beam is increased for recording and decreased for reproduction. The second laser source LD2 is connected to the second laser source driving circuit 25b.

The polarizing spatial light modulator SLM of reflection type has a function of electrically transmitting or blocking a part or all of incident light with a liquid crystal panel or the like having a plurality of pixel electrodes that are divided in a matrix shape or the like. The polarizing spatial light modulator SLM, which is connected to the first laser source driving circuit 25a, modulates and reflects an light beam so as to have a polarization component distribution based on page data to be recorded (two-dimensional data of information pattern such as bright and dark dot pattern or the like on a plane) from the spatial light modulator driving circuit 26 to generate signal light. Further, instead of the polarizing spatial light modulator SLM, in case that a transparent liquid crystal panel having a plurality of pixel electrodes divided into a matrix is used as the spatial light modulator, the modulator is arranged between the first and second half mirror prisms HP1 and HP2.

The reproduced signal detector including the image sensor IS is connected to the reproduced signal processing circuit 27.

Further, the pickup device 23 is provided with the objective lens actuator 36 for moving the objective lens OB in the optical axis (z direction) parallel direction, and in a track (y direction) parallel direction, and in a radial (x direction) direction perpendicular to the track.

The photodetector PD is connected to the servo signal processing circuit 28, and has the shape of light receiving element divided for focusing servo and x and y direction movement servo generally used for optical disks. The servo scheme is not limited to an astigmatism method, but can employ a push-pull method. The output signal of the photodetector PD, such as a focus error signal and a tracking error signal etc. is supplied to the servo signal processing circuit 28.

In the servo signal processing circuit 28, a focusing driving signal is generated from the focus error signal, and is supplied to the focusing servo circuit 29 through the controller circuit 37. The focusing servo circuit 29 drives the focusing section of the objective lens actuator 36 mounted in the pickup device 23, so that the focusing section operates to adjust the focus position of an optical spot irradiated to the holographic record carrier.

Further, in the servo signal processing circuit 28, x and y direction movement driving signals are generated from x and y direction movement error signals, and supplied to the x-direction movement servo circuit 30x and y-direction movement servo circuit 30y, respectively. Thus the x-direction movement servo circuit 20x and the y-direction movement servo circuit 30y drive the objective lens actuator 36 mounted on the pickup 23 according to the x- and y-direction movement driving signals. Therefore, the objective lens is driven by the amount of driving current according to the driving signal along the x, y and z axes, and then the position of the focal point incident on the holographic record carrier is displaced. Accordingly, it is possible to fix a relative position of the focal point with respect to a moving holographic record carrier and then to guarantee time to form the hologram when recording data.

The controller circuit 37 generates a slider driving signal based on a position signal from the operation panel or the pickup position detecting circuit 31 and the x direction movement (tracking) error signal from the servo signal processing circuit 28, and supplies the slider driving signal to the slider servo circuit 32. The slider servo circuit 32 moves the pickup device 23 in the radial direction of the disk in response to a driving current carried with the slider driving signal by the pickup actuator 24.

The rotation encoder 33 detects a frequency signal indicative of a current rotating frequency of the spindle motor 22 for rotating the holographic record carrier 2 through the turn table, generates a rotational speed signal indicative of the spindle rotational signal corresponding thereto, and supplies the rotational speed signal to the rotation detector 34. The rotation detector 34 generates a rotational speed position signal which is supplied to the controller circuit 37. The controller circuit 37 generates a spindle driving signal which is supplied to the spindle servo circuit 35 to control the spindle motor 22 for driving the holographic record carrier 2 to rotate.

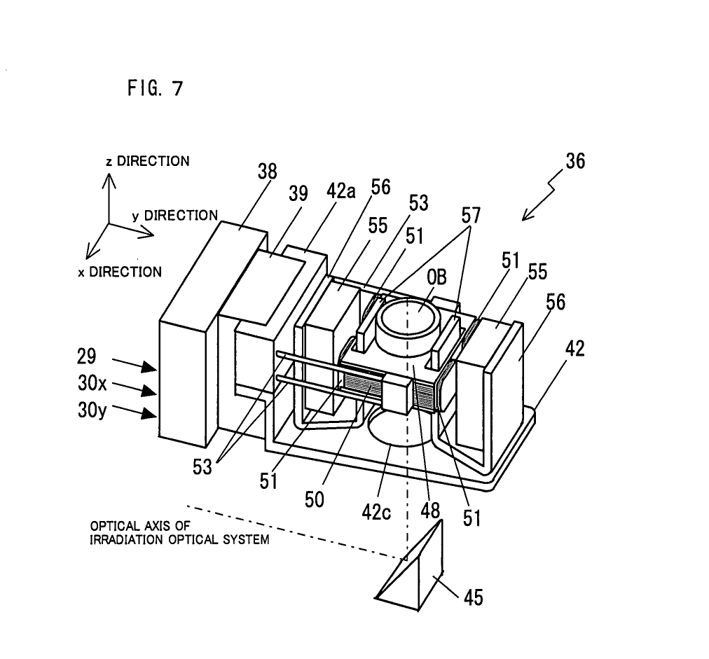

FIG. 7 shows the objective lens actuator 36 of the pickup for the holographic recording/reproducing apparatus of this embodiment.

The objective lens actuator 36 comprises an actuator base 42 which can swing in the y-direction by a piezo element 39 which is coupled to a support 38 secured to a pickup body (not shown). Within the pickup body, there are the aforementioned optical parts required for making up the pickup such as the prism 45 for reflecting a light beam from the laser at right angles for leading the light beam to the objective lens OB, and the like. The light beam passes through an opening 42c and the objective lens OB, and is converged to spot light which is irradiated to an information recording surface of the medium on the turn table.

As shown in FIG. 7, the objective lens OB is mounted on a protrusion at an upper end of a lens holder 48 which is formed in a cylindrical shape, and makes up a movable optical system together with the objective lens. A focusing coil 50 is wound around the outer periphery of the lens holder 48 such that the central axis of the coil is in parallel with the optical axis of the objective lens OB. Four tracking coils 51, for example, are disposed outside of the focusing coil 50 such that the central axes of the coils are perpendicular to the optical axis of the objective lens OB. Each tracking coil 51 is previously wound in a ring shape, and adhered on the focusing coil 50. The movable optical system made up of the objective lens OB and lens holder 48 is supported at one end of two pairs, i.e., a total of four longitudinal supporting members 53 which are spaced apart from each other in the optical axis direction of the objective lens OB and extend in the y-direction perpendicular to the optical axis direction. However, FIG. 7 shows only three of the supporting member 53. Each supporting member 53 is cantilevered at a distal end of an extension 42a secured to the actuator base 42. Each supporting member 53 is made of a coil material or the like, and therefore has a resiliency. The movable optical system made up of the objective lens OB and lens holder 48 is movable in the x-, y-, and z-directions by the four longitudinal supporting members 53 and aforementioned piezo element 39.

The lens holder 48 is spaced apart from and sandwiched between a pair of magnetic circuits. Each magnetic circuit comprises a magnet 55 facing the lens holder 48, and a metal plate 56 for supporting the magnet 55, and is secured on the actuator base 42. The lens holder 48 is formed with a pair of throughholes which are positioned to sandwich the objective lens OB in parallel with the optical axis of the objective lens OB and the central axis of the coil inside the focusing coil 50 of the lens holder 48 in a direction in which the longitudinal supporting members 53 extend. A yoke 57, which extends from the metal plate 56 of the magnetic circuit, is inserted into each through hole without a contact therebetween. The focusing coil 50 and tracking coil 51 are positioned within a magnetic gap of the magnetic circuit which is made up of the magnet 55 and yoke 57.

The focusing coil 50, tracking coil 51, and piezo element 39 are controlled by the focusing servo circuit 29, x-direction movement servo circuit 30x, and y-direction movement servo circuit 30y, respectively. Since parallel magnetic flux crossing perpendicularly to the respective coils can be generated in the magnetic gap, driving forces in the x- and z-directions can be generated by supplying predetermined currents to the respective coils to drive the aforementioned movable optical system in the respective directions.

In this way, voice coil motors are used to drive the objective lens OB in the x- and y-directions, and the objective lens OB is driven for the y-direction together with the actuator base using a piezo element or the like. Other than the foregoing structure, the actuator may use voice coil motors for all the axes.

### <Method of Recording and Reproducing Hologram>

Description will be made on a recording and reproducing method for recording or reproducing information by irradiating a holographic record carrier with an light beam using the holographic recording and reproducing apparatus described above.

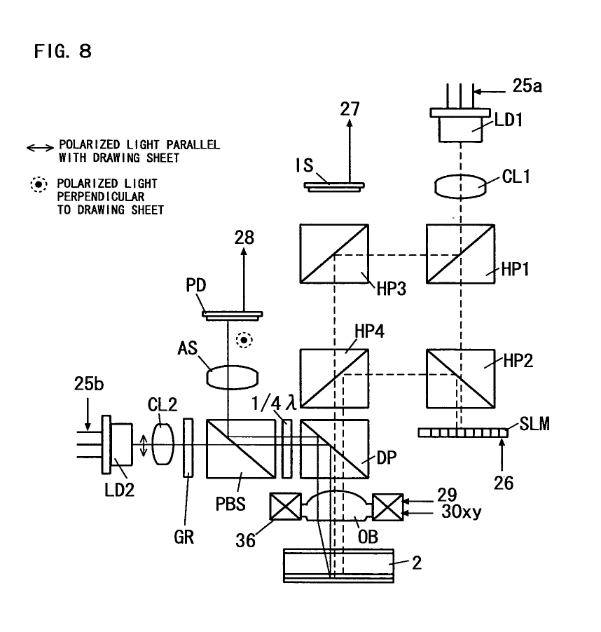

During recording, as shown in FIG. 8, coherent light having a predetermined intensity from the first laser source LD1 is separated into a reference beam and a signal beam by the first half mirror HP1 (both the beams are indicated by broken lines and are shifted from the optical axis of FIG. 6 for explaining the optical path).

The signal beam transmits the second half mirror prism HP2, and impinges on the polarizing spatial light modulator SLM along the normal of the reflective surface. The signal light modulated in a predetermined manner by and reflected from the polarizing spatial light modulator SLM again impinges on the second half mirror prism HP2 and directs to the fourth half mirror prism HP4.

The reference beam is reflected by the third half mirror prism HP3, and directs to the fourth half mirror prism HP4.

The reference light and the signal light are combined so as to be substantially coaxial by using the fourth half mirror prism HP4. The two combined light beams pass through the dichroic prism DP, and are converged on the holographic record carrier 2 by the objective lens OB for recording a hologram.

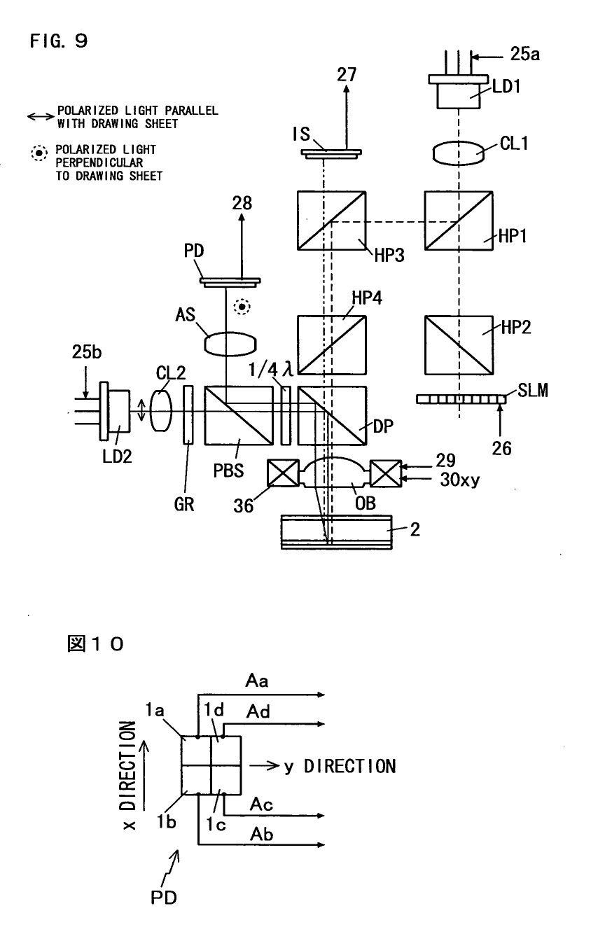

During information reproduction, on the other hand, light is separated into a reference beam and a signal beam by the first half mirror HP1, in a manner similar to the recording, as shown in FIG. 9, however, holograms are reproduced only with the reference beam. By bringing the polarizing spatial light modulator SLM into a non-reflective state (light-permissible state), only reference light from the third half mirror HP3 passes through the dichroic prism DP and objective lens OB, and impinges on the holographic record carrier 2.

Since reproduced light (two-dot chain line) generated from the holographic record carrier 2 transmits the objective lens OB, dichroic prism DP, fourth half mirror prism HP4, and third half mirror prism HP3, and impinges on the image sensor IS. The image sensor IS delivers an output corresponding to an image formed by the reproduced light to the reproduced signal processing circuit 27 which generates a reproduced signal that is supplied to the controller circuit 50 for reproducing recorded page data. In addition, an image forming lens may be provided between the third half mirror prism HP3 and the image sensor IS.

Here, a position decision servo control is performed with respect to the holographic record carrier or hologram disk 2 in both recording and reproduction of the hologram. According to the position decision servo control, three axes actuator (objective lens actuator 36) is capable of driving the objective lens along the x, y, and z-directions, by an error signal operated and obtained based the output of the photodetector PD.

During both recording and reproduction, the second laser source LD2 for servo control emits coherent light at a different wavelength from the first laser source LD1, as shown in FIGS. 8 and 9. The servo light beam (thin solid line) from the second laser source LD2 is P-polarized light (double-head arrow indicating the parallelism to the drawing sheet) which is led along an optical path for servo detection including the second collimator lens CL2, polarization beam splitter PBS and ¼ wave plate ¼λ, but is combined with the signal beam and reference beam by the dichroic prism DP immediately before the objective lens OB. The servo light beam, after reflected by the dichroic prism DP, is converged by the objective lens OB, and impinges on the holographic record carrier 2. Return light of the servo light beam reflected from the holographic record carrier 2 back to the objective lens OB and then transformed by the ¼ wave plate ¼λ into S-polarized light (a black circle surrounded by a broken-line circle indicative of being perpendicular to the drawing sheet) which impinges on a light receiving surface of the servo photodetector PD along the normal thereof through the polarization beam splitter PBS and astigmatism element AS.

Further, the z-direction servo (focusing servo) control along the z-direction may be performed by the astigmatic method, three-beam method, spot size method and push/pull method that are used in a conventional light pickup or a combination thereof may be used.

With the astigmatism method, for example, a central portion of the photodetector PD comprises light receiving elements 1a-1d having a light receiving surface equally divided into four for receiving a beam, for example, as shown in FIG. 10. The directions in which the photodetector PD is divided correspond to the radial direction of the disk and a tangential direction of the guide tracks. The photodetector PD is set such that a focused light spot appears to be a circle centered at the intersection of lines which divide the photodetector PD into the light receiving elements 1a-1d.

In accordance with output signals of the respective light receiving elements 1a-1d of the photodetector PD, the servo signal processing circuit 28 generates an RF signal Rf and a focus error signal. When the signals of the light receiving elements 1a-1d are labeled Aa−Ad, respectively, in this order, the focus error signal FE is calculated by EF=(Aa+Ac)−(Ab+Ad), and the tracking error signal TE is calculated by TE=(Aa+Ad)−(Ab+Ac). These error signals are supplied to the controller circuit 37.

### <Detailed Record and Reproduction>

In the present embodiment, a position decision servo control with the holographic record carrier 2 is always performed by the servo beam SB. Simultaneously, the reproduction of the hologram is performed using the first light beam FB (reference light) and recording of the same is performed using the first light beam FB (reference light and signal light).

As shown in FIG. 11, focal points of the servo beam SB and the first light beam FB are arranged on a track of the reflective layer 5 in a nearly identical manner when recording and reproducing.

The recording of the hologram is performed by interfering components of the reference light and signal light of the first light beam FB in the holographic recording layer 7. Since the modulation signal (signal light component) modulated in the polarizing spatial light modulator SLM is a diffraction light component more than 1st order, it has a considerable area in the vicinity of a condensing spot (Fourier surface). Accordingly, a beam is substantially reflected from the reflective layer 5. Meanwhile, since the reference light (or Zero-order component) is unmodulated DC light, it has a spot size that is determined by the number of the openings and wavelength of the objective lens OB. Further, when a pinhole PH is somewhat larger than the spot size, the reference light passes through the pinhole PH.

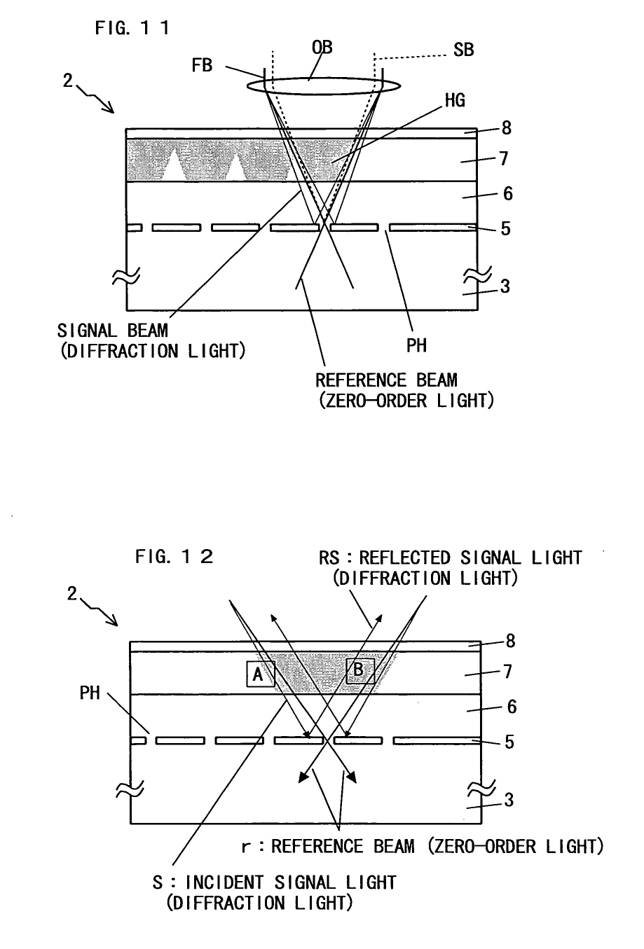

As shown in FIG. 12, when recording the hologram, since the reference light passes through the pinhole PH, interference occurs between the incident reference light r and the incident signal light S, and an interference of the incident reference light r and the reflected signal light RS in the holographic recording layer 7, and the holograms A and B are formed on the basis of each interference. Since the reference light r passes through a rear side of the holographic record carrier 2, it is not possible to form the hologram using the reflected reference light.

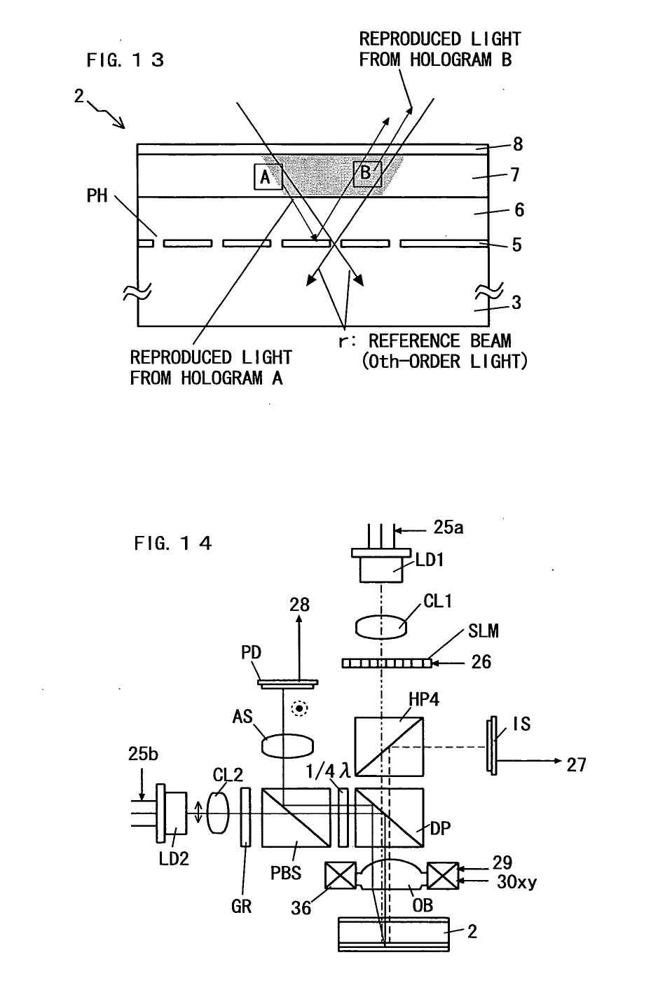

As shown in FIG. 13, even in the case of reproducing the hologram, the reference light for reproduction is matched with the pinhole. By doing such an operation, the reference light passes through a rear side of the holographic record carrier 2 via the pinhole PH. Since the reference light is not returned to the objective lens OB, the reference light is never returned and incident to the image detection sensor IS. In a reproduction of the recorded hologram, the reproduced signal B is generated to the objective lens OB side in the hologram B by the reference light incident to the holographic record carrier 2. Further, the reproduced signal A is generated to the opposite side of the objective lens OB in the hologram A. The generated signal A is reflected from the reflective layer 5 and returned to the objective lens OB side. The reproduced signals A and B are identical and overlapped on the light-receiving element so that no problem occurs.

### Holographic Device of Another Embodiment

FIG. 14 explains an example where recording of a hologram is performed without dividing the reference light and signal light, and a laser light source of different wavelength is used to control a relationship (focusing, tracking) of a holographic record carrier and a pickup, when recording and reproducing the hologram.

The holographic device shown in FIG. 14 omits first, second and third half mirror prisms HP1, HP2 and HP3 of the record optical system, arranges a first laser light source LD1 and a first collimator lens CL1 in the position of an image detection sensor IS, and arranges the image detection sensor IS in the position of the second half mirror prism HP2. Further, by inserting a transparent polarizing spatial light modulator SLM between the fourth half mirror prism HP4 and a first collimator lens CL1 instead of a reflective spatial light modulator, a reproduced wave returned from the carrier by inserting the objective lens OB is branched by the fourth half mirror prism HP4. The configuration is identical to that of FIG. 6 except the configuration described above. The laser light from a first laser light source LD1 is converted into a parallel beam by the collimator lens CL1 and is then incident onto the transparent polarizing spatial light modulator SLM. The polarizing spatial light modulator SLM has a movement to spatially modulate a part of the incident light to a liquid crystal panel having an electrode divided in a matrix shape or the like electrically. Using the polarizing spatial light modulator SLM, page data is modulated as an intensity distribution among the signal light. The beam out of the polarizing spatial light modulator SLM becomes a first light beam FB consisted of a diffraction light (signal light component) of 1 or greater order and non-modulated Zero-order light (reference light component). The first light beam FB of the signal light and reference light is focused on the holographic record carrier 2 50 that the hologram is recorded. That is, the hologram reproduction system has a support unit for maintaining a holographic record carrier to be mounted other than a principal part of the record optical system, a light source for generating a coherent reference light, an interference unit for irradiating the reference light on a diffraction grating formed in an internal part of a recording layer of the holographic record carrier according to record information and reproducing a reproduction wave, a dividing unit for dividing a return light reflected from the reflective layer of the reference light and returned to the interference unit and a reproduction wave, and a detector for detecting the record information imaged by the reproduction wave.

In the reproduction operation, a first light beam consisting of non-modulated laser light, that is, Zero-order light (reference light component) in the transparent polarizing spatial light modulator SLM is condensed on the holographic record carrier 2 through the objective lens OB, the reproduced wave is reconstructed and returned to a pickup through the objective lens OB. The component reflected from the fourth half mirror prism HP4 is incident on the image detection sensor IS. The image detection sensor IS transfers an output corresponding to an image generated using the reproduced light to the reproduction signal detection processing circuit 27, provides the control circuit 50 with the reproduction signal generated there and reproduces page data that has been recorded. The configuration of the servo beam SB (servo control) is identical to the configuration shown in FIG. 6.

### EXAMPLE 1

As shown in FIG. 15, each of pitches Px and Py of the pinhole PH Px of the refractive layer 5 is set as a predetermined distance which is determined by a multiplicity of holograms HG recorded above the spot of the first light beam FB. A maximum multiplicity in an actual shift multiplex recording hologram system (i.e., a value (number of times) indicating how many independent holograms can be recorded within the same volume in a holographic recording medium) is determined by the medium and the configuration of the apparatus, as mentioned above. A minimum pitch Px (i.e., a minimum shift distance) is set by a span of a recorded hologram area divided by the maximum multiplicity. The track pitch Px is set at the minimum shift distance or more.

A position determination servo control with the holographic record carrier 2 is always performed by using the servo beam SB and at the same time, recording of the hologram is performed using a first light beam FB. The servo control may be performed by irradiating a plurality of servo beams on a vicinity pinhole PH.

### EXAMPLE 2

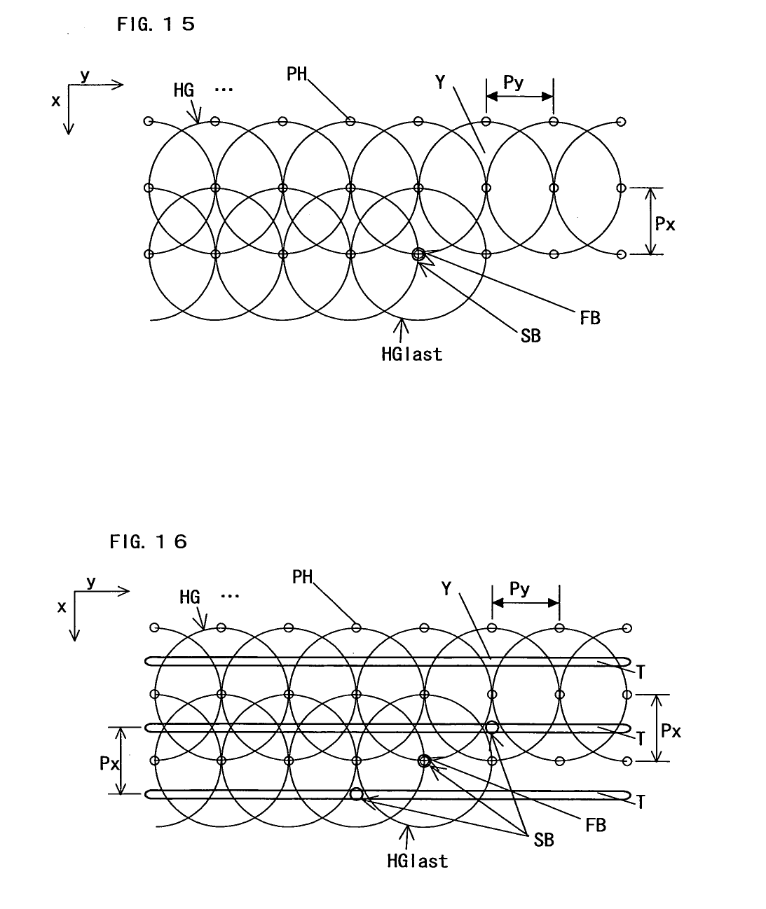

As shown in FIG. 16, in case that the same track T as the holographic recording interval Py is formed between mark arrays of the pinhole PH, while the servo beam SB is set 3 beams by the diffraction optical device such as a grating and the x and y direction servo is performed using 2 side beams, recording is performed using the main beam. That is, a optical axis of the first light beam FB is arranged and tracking servo controlled in order to position the first light beam FB on a straight line or in the center of the light spot of 3 servo beams SB, and the holographic recording is performed in the holographic recording layer 7 of an upper part of a mirror plane part between adjacent tracks.

### EXAMPLE 3

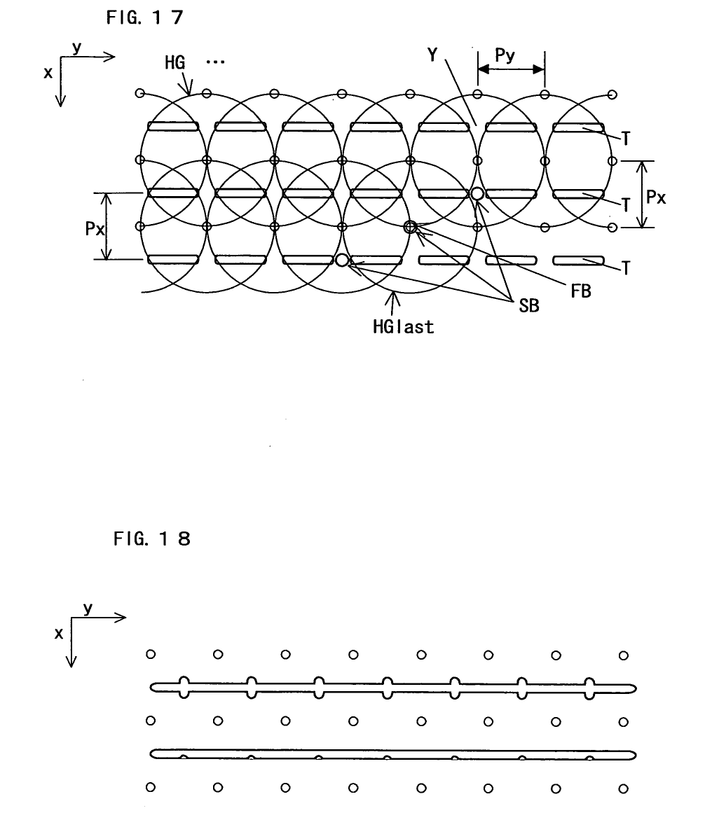

As shown in FIG. 17, a hologram multiple interval Px is set along the x-direction, and a track T extending along the y-direction of the hologram multiple direction and a mask Y identical to the multiple interval Py along the y-direction can be formed in a disk format. The track T of the reflective layer 5 is also the pitch Px, which is set by a predetermined distance determined as a multiplicity of the hologram HG that is recorded in an upper part of the spot of the first light beam FB. As shown in the drawing, when recording the hologram, the servo beam SB is divided into 3 beams by the grating. In order that the main beam in the center of the servo beam is arranged between the tracks T, the side beam is arranged on the track T. Tracking servo control is performed where the objective lens OB follows the track T using the push/pull method from the detection signal of the side beam. The spot of the first light beam is matched with the pinhole PH by moving the holographic record carrier 2 along the y-direction by the interval Py.

As to the servo beam SB, a time axis servo control is simultaneously performed where the objective lens OB is also followed along the y-direction using a mark Y along the y-direction by adding the servo beam SB to the same tracking servo control as is in Example 1. Since the servo control by the servo beam SB is the same with the Example 1, a detailed description thereof will be omitted.

### EXAMPLE 4

Although the mark Y having the same holographic recording interval in the extending direction in the track T of the Example 3 shown in FIG. 17 has a shape where a glove is partially cut, the mark Y−1 may have a shape where a part of the track seems to be swollen or where a part of the track seems to be cut, in other shape of mark as is shown in FIG. 18.

### EXAMPLE 5

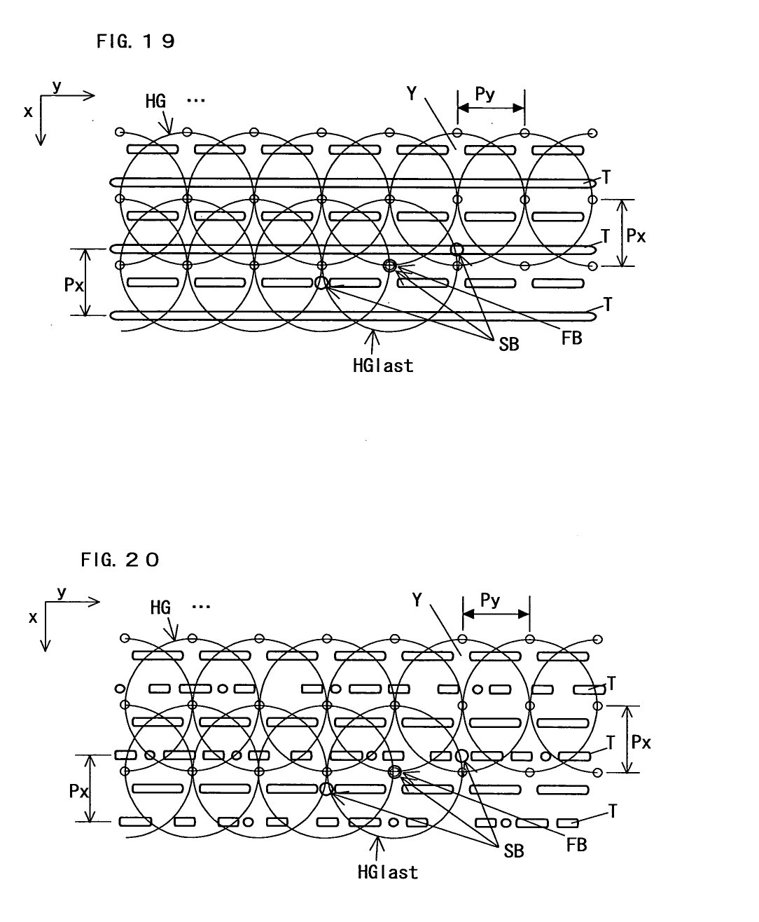

As shown in FIG. 19, the tracks T1 and T2 adjacent along the x-direction may be arranged in the same manner that an array of the pinhole PH arranged along the y-direction is inserted. The lost parts (mark Y) of the track T1 are set in the same interval as a holographic recording interval. The track T2 is the same as that of Example 2 shown in FIG. 16. The track interval Px of the same kind is set in the same interval as the holographic recording interval.

### EXAMPLE 6

As shown in FIG. 20, the tracks T1 and T2 adjacent along the x-direction may be arranged in the same manner that an array of the pinhole PH arranged along the y-direction is inserted. The track T2 is a pit array or a mark array in which a variety of information, other than address information, is previously recorded. The track T1 is the same as that of Example 2 shown in FIG. 19. The track interval Px of the same kind is set in the same interval as the holographic recording interval.

As described above, according to the present embodiment of the present invention, since the reference light is always prevented from being returned to the non-reflective region such as the pinhole PH on the reflective layer, the diffraction light from a reproduced hologram can be divided. When recording the hologram, since only the reference light effectively becomes non-reflective, a surplus hologram such as a reflected image is not recorded. As a result, the holographic recording layer is not deteriorated unnecessarily. Further, since the reference light is not returned to the detector when reproducing a hologram, it is possible to receive the diffraction light only from the hologram needed to reproduce the signal. As a result, a SN ratio (signal to noise ratio) of data reproduction is improved so that it is possible to perform stable reproduction.

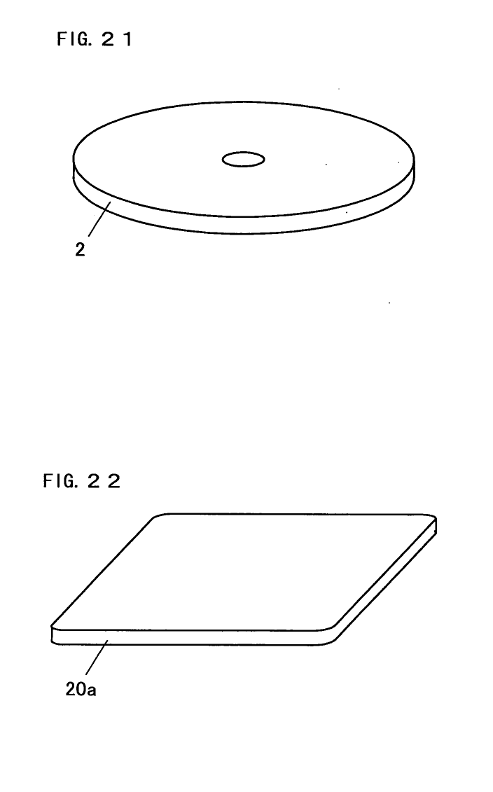

Besides, though the foregoing embodiment includes the holographic record carrier 2 as shown in FIG. 21 as a record carrier, the shape of the holographic record carrier is not limited to a disk. For example, the embodiment includes as shown in FIG. 22 an optical card 20a of a rectangle parallel flat board made of plastics and the like and having. In such optical card, the guide track may be formed on the substrate spirally or spiroarcually or concentrically with respect to the center e.g., of gravity of the substrate. Further, the guide track may be formed in parallel on the substrate.

Furthermore, in the embodiment described above, a case where holographic recording, mark record and servo control are performed is explained using the first light beam FB and the servo beam SB (second light beam) from the first and second laser light source LD1 and LD2, the first and second beams having different wavelengths with each other. In addition to such embodiment, it is possible to use first and second light sources LD1 and LD2 can project laser light having the same wavelength. In this case, for example, while performing the servo control by controlling the light intensity of the servo beam SB below the level so as not to reach holographic recording, the first light beam FB is irradiated only when the holographic recording is needed.

1. A holographic record carrier which is irradiated with light for recording information thereon and reproducing information therefrom, comprising:
a holographic recording layer for storing optical interference patterns as diffraction gratings therein produced by coherent components of reference light and signal light;
a reflective layer disposed on one side of said holographic recording layer opposite to a side which is irradiated with light; and
a plurality of non-reflective regions arranged on said reflective layer at the same intervals as record-intervals of said diffraction gratings.

2. The holographic record carrier according to claim 1, wherein each of said non-reflective regions is a pinhole.

3. The holographic record carrier according to claim 1, wherein each of said non-reflective regions has a permeability of a characteristic value higher than that of said reflective layer.

4. The holographic record carrier according to claim 1, wherein each of said non-reflective regions has an absorption ratio of a characteristic value higher than that of said reflective layer.

5. The holographic record carrier according to claim 1, wherein each of said non-reflective regions has a reflectivity of a characteristic value lower than that of said reflective layer.

6. The holographic record carrier according to claim 3, wherein the characteristic value of said non-reflective regions is a characteristic value in a wavelength of said coherent reference light and signal light.

7. The holographic record carrier according to claim 1, wherein said reflective layer has tracks each traced by a spot of a light beam passing through the holographic recording layer and said reflective layer from an objective lens and being converged thereon, wherein the tracks are extended without intersecting each other.

8. The holographic record carrier according to claim 7, wherein the tracks are formed in a spiral shape, a spiral arc shape or an eccentric circle shape.

9. The holographic record carrier according to claim 7, wherein the tracks are formed in parallel.
